(19) United States
(12) Patent Application Publication
(10) Pub. No.: US 2026/0027392 A1
(43) Pub. Date: Jan. 29, 2026

(54) HANDLES FOR SAFETY HARNESS AND SAFETY HARNESS INCLUDING THE SAME

(71) Applicant: WERNER CO., ITASCA, IL (US)

(72) Inventors: Tracee Leonardson, Ashtabula, OH (US); Kendal King, Mars, PA (US); Cody Rappoport, Greenville, PA (US)

(73) Assignee: WERNER CO., ITASCA, IL (US)

(21) Appl. No.: 19/280,762

(22) Filed: Jul. 25, 2025

Related U.S. Application Data
(60) Provisional application No. 63/675,799, filed on Jul. 26, 2024.

(51) Int. Cl. A62B 35/00

(52) U.S. Cl. CPC A62B 35/0025; A62B 35/0012

(57) ABSTRACT

A handle for a safety harness includes a handle portion, a first leg portion extending from a first end of the handle portion, a second leg portion extending from the first end of the handle portion, a first attachment element attached to a portion of the handle portion distal from the first end of the handle portion, and a second attachment element attached to a portion of the first leg portion or the second leg portion distal from the first end of the handle portion, wherein the first attachment element is structured to selectively attach to the second attachment element.

### CROSS REFERENCE TO RELATED APPLICATIONS

This application claims priority to U.S. Provisional Patent Application Ser. No. 63/675,799, filed on Jul. 26, 2024, and titled “HANDLES FOR SAFETY HARNESS AND SAFETY HARNESS INCLUDING THE SAME” the disclosure of which is incorporated herein by reference.

### FIELD OF THE INVENTION

The disclosed concept relates generally to fall protection systems, and in particular, to safety harnesses for use in fall protection systems and leg strap handles for such safety harnesses.

### BACKGROUND OF THE INVENTION

In fall protection systems, a worker typically wears a safety harness with an attached lifeline. The lifeline is then attached to an anchor, such as, for example and without limitation, a roof anchor or other type of anchoring point. If a worker begins to fall, the lifeline, harness, and anchor, working together, are operable to suspend the fall and bear the worker's weight. In some cases the worker may need to remain in the suspended position for an extended period of time. For example, a worker that falls from the roof of a building may be suspended on the side of the building until they are able to be retrieved.

Many type of safety harnesses are full body harnesses that include shoulder straps and leg straps. The shoulder straps and leg straps are typically formed from woven webbing material such as nylon or other similar materials. The lifeline is usually attached to the back of the harness around where the shoulder straps meet each other.

In the period immediately after a fall, the worker is generally suspended in a vertical orientation, similar to the position the worker would be when standing. When suspended in the vertical position, the force applied by the leg straps to support the worker's weight can be uncomfortable and unhealthy if maintained for an extended period of time. In the suspended position, it is difficult for the worker to reduce the force applied by the leg straps.

### SUMMARY OF THE INVENTION

In accordance with an example embodiment of the disclosed concept, a handle for a safety harness comprises: a handle portion; a first leg portion extending from a first end of the handle portion; a second leg portion extending from the first end of the handle portion; a first attachment element attached to a portion of the handle portion distal from the first end of the handle portion; and a second attachment element attached to a portion of the first leg portion or the second leg portion distal from the first end of the handle portion, wherein the first attachment element is structured to selectively attach to the second attachment element.

In accordance with an example embodiment of the disclosed concept, a handle for a safety harness comprises: a handle portion; a first leg portion extending from a first end of the handle portion; a second leg portion extending from the first end of the handle portion; and a gripping element attached to a second end of the handle portion distal from the first end, wherein the handle portion is structured to selectively attach to and lay flush against the first leg portion or second leg portion, and wherein the handle portion is structured to selectively detach from and extend away from the first leg portion or the second leg portion.

In accordance with an example embodiment of the disclosed concept, a safety harness comprises: a first leg strap structured to loop around a first leg of a user; and a first handle attached to the first leg strap, the first handle comprising: a handle portion; a first leg portion extending from a first end of the handle portion; a second leg portion extending from the first end of the handle portion; a first attachment element attached to a portion of the handle portion distal from the first end of the handle portion; and a second attachment element attached to a portion of the first leg portion or the second leg portion distal from the first end of the handle portion, wherein the first attachment element is structured to selectively attach to the second attachment element.

### BRIEF DESCRIPTION OF THE DRAWINGS

A full understanding of the invention can be gained from the following description of the preferred embodiments when read in conjunction with the accompanying drawings in which:

FIG. 1 is a view of a handle for a safety harness in accordance with an example embodiment of the disclosed concept;

FIG. 2 is another view of a handle for a safety harness in accordance with an example embodiment of the disclosed concept;

FIG. 3 is an isometric view of a handle for a safety harness in accordance with an example embodiment of the disclosed concept;

FIG. 4 is a front view of a handle for a safety harness in accordance with an example embodiment of the disclosed concept;

FIG. 5 is a side view of a handle for a safety harness in accordance with an example embodiment of the disclosed concept;

FIG. 6 is a rear view of a handle for a safety harness in accordance with an example embodiment of the disclosed concept;

FIG. 7 is a view of a knob for a handle for a safety harness in accordance with an example embodiment of the disclosed concept;

FIG. 8 is a view of a user wearing a safety harness including handles in accordance with an example embodiment of the disclosed concept;

FIG. 9 is a view of a portion of a safety harness including a handle in accordance with an example embodiment of the disclosed concept;

FIG. 10 is a view of a portion of safety harness including handles in accordance with an example embodiment of the disclosed concept; and

FIG. 11 is a view of a portion of a safety harness including a handle in accordance with an example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

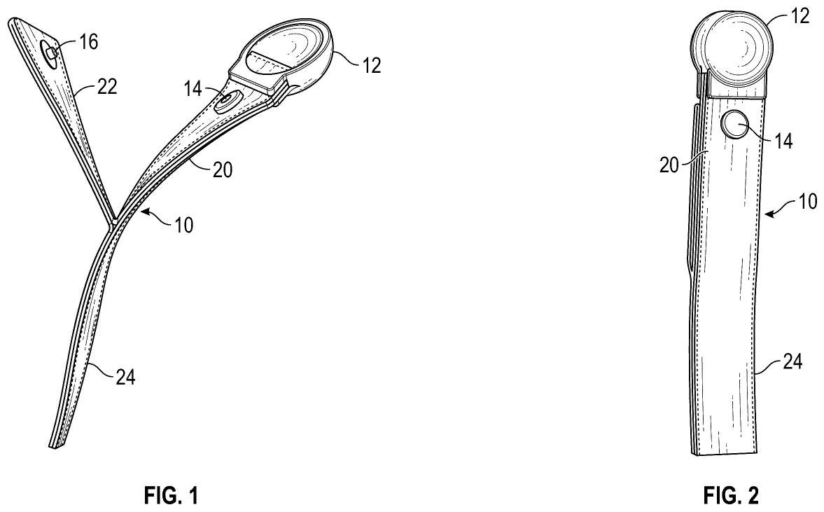

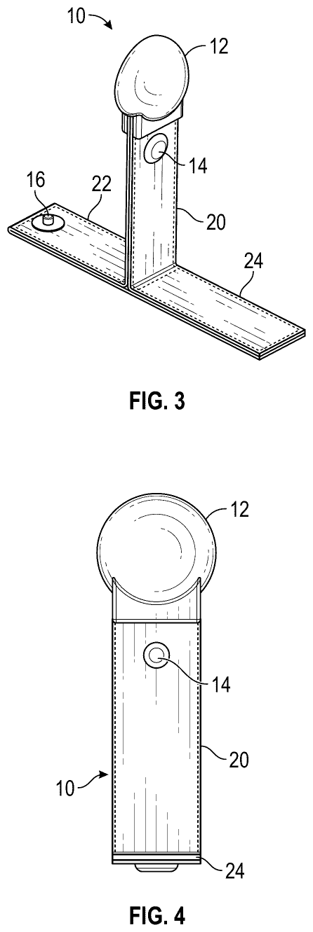

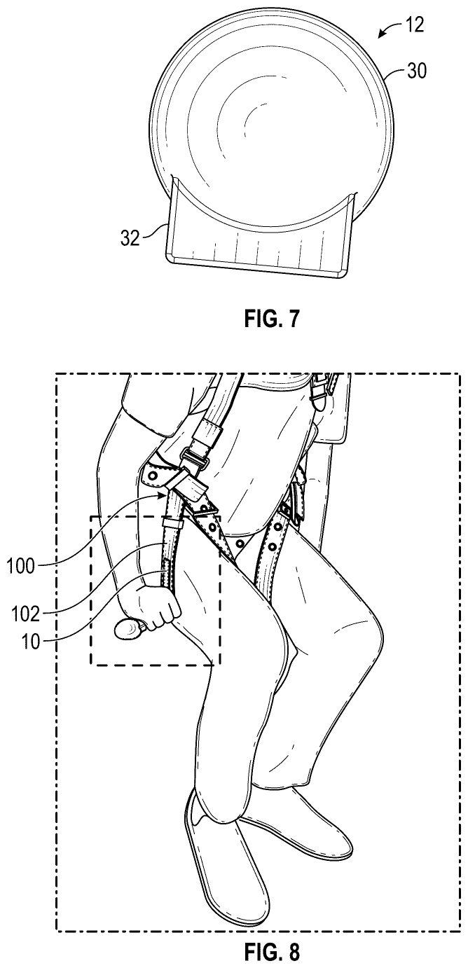

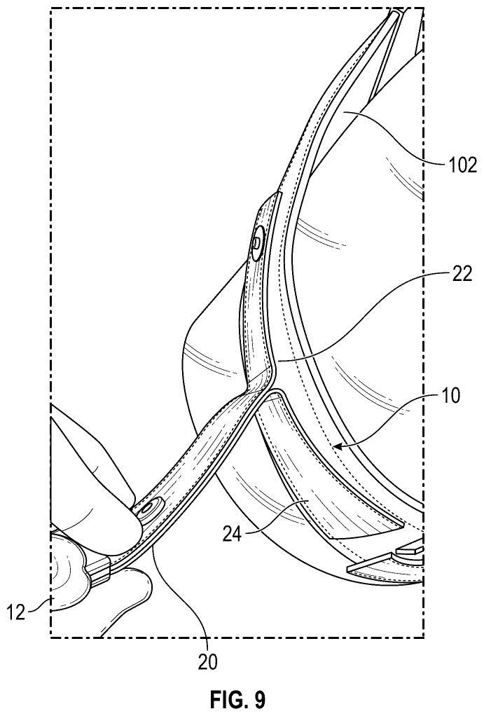

FIG. 1 is a view of a handle 10 for a safety harness in accordance with an example embodiment of the disclosed concept. FIG. 2 is another view of the handle 10 in accordance with an example embodiment of the disclosed concept. FIG. 3 is an isometric view of the handle 10 in accordance with an example embodiment of the disclosed concept. FIGS. 4, 5, and 6 are front, side, and rear views, respectively, of the handle 10 in accordance with an example embodiment of the disclosed concept. FIG. 7 is a view of a knob 12 for use with the handle 10 in accordance with an example embodiment of the disclosed concept. FIG. 8-11 are views of safety harness 100 including handles 10 in accordance with example embodiments of the disclosed concept.

A safety harness 100 (shown for example in FIG. 8) for fall protection is worn by a user. The safety harness 100 may be composed of a number of straps including leg straps 102 structured to wrap around legs of the user. An attachment point of the safety harness 100, for example a D-ring, is coupled to an anchor point via a lifeline, such as for example and without limitation, a self-retracting lifeline. In the case of a fall, the fall of the user is arrested via one or more components such as, for example and without limitation, the self-retracting lifeline and an energy absorber. After the fall is arrested, the user may be in a state of suspension where they are hanging in the air, supported by the safety harness 100 which remains coupled to the anchor point. In an initial hanging position, the user may be in a vertical position in which the safety harness 100 applies pressure to the femoral artery in the groin area. For example, in a vertical hanging position, leg straps 102 of the safety harness 100 support the weight of the user and apply pressure to the groin area of the user in the area of the femoral artery. Suspension trauma is caused when pressure is applied to the femoral artery for an extended amount of time, such as when the user is hanging from the safety harness 100 in a vertical position after a fall event for an extended amount of time.

To relieve pressure on the femoral artery when in a vertical position after a fall, the user of the safety harness 100 can adjust to a sitting position (shown for example in FIG. 8). In the sitting position, the weight of the user is still supported by the leg straps 102 of the safety harness 100. However, the user is in a seated position where the leg straps 102 apply pressure to the backs of the user's thighs rather than to the groin area in the area of the femoral artery. The user can maintain the seated position in the safety harness 100 for an extended period of time with a reduced risk of suspension trauma as pressure is not applied to the femoral artery in the seated position. To adjust from the vertical position to the seated position, the user must adjust the position of the leg straps 102 so that the leg straps 102 apply pressure to the backs of the user's thighs rather than to the user's groin area. With the user's weight supported by the leg straps 102, it can be difficult to adjust from the vertical position. The user typically needs to pull the leg straps 102 downward to relieve the pressure of the leg straps 102 against the user and then to slide the leg straps 102 so that they are positioned at the back of the user's thighs while adjusting to a seated position. The user can then release the leg straps 102 and maintain a seated position where the leg straps 102 support the weight of the user by applying pressure to the backs of the user's thighs.

In typical safety harnesses, when the user is in the vertical position after a fall, it can be difficult to pull the leg straps down to relieve sufficient pressure to adjust to a seated position. In accordance with example embodiments of the disclosed concept, handles 10 for the safety harness 100 allow the user to pull the leg straps 102 downward to relieve pressure of the leg straps 102 and adjust to a seated position (shown for example in FIG. 8) in the safety harness 100, thus relieving pressure on the femoral artery.

The handles 10 in accordance with an example embodiment of the disclosed concept include a body composed of webbing. The webbing may be, for example and without limitation, a woven webbing material such as nylon or other similar materials. In some example embodiments, the webbing of the handles 10 may be composed of the same or similar material as straps of the safety harness 100. However, it will be appreciated that the body of the handles 10 may be composed of different materials with departing from the scope of the disclosed concept.

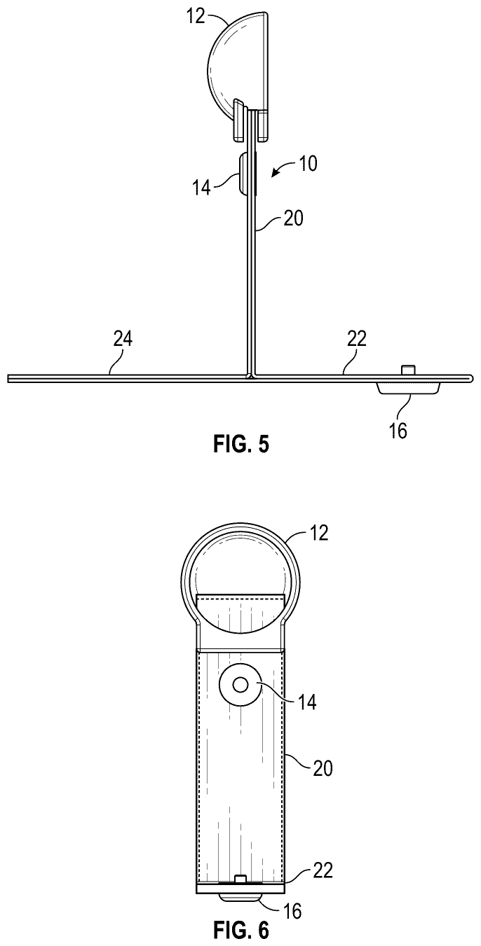

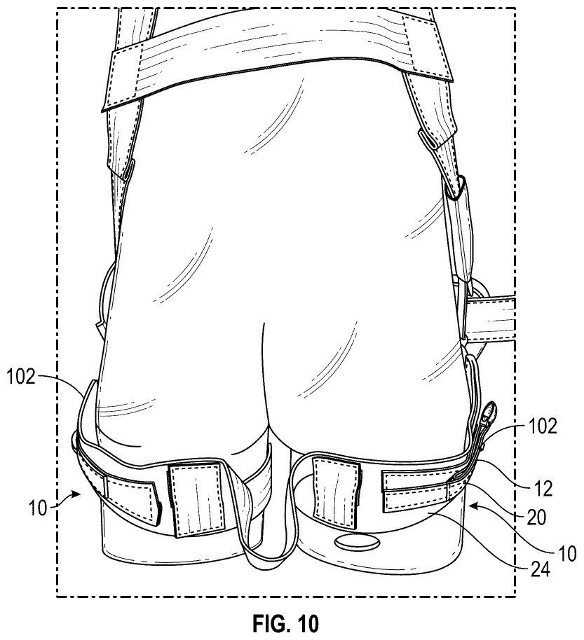

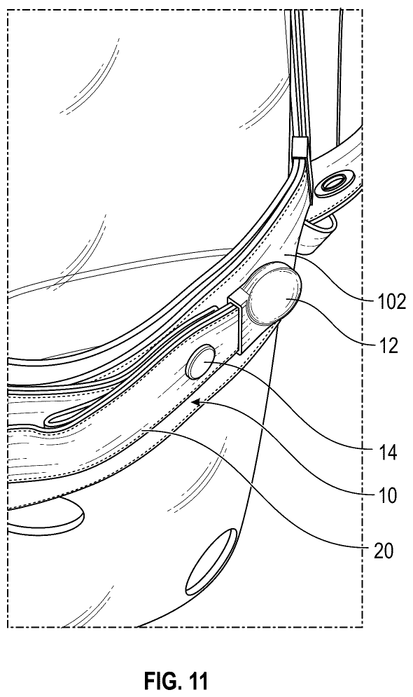

FIGS. 1-6 are various views of one of the handles 10 in accordance with an example embodiment of the disclosed concept. It will be appreciated that the handle 10 may be attached to one leg strap 102 of the safety harness 100 and another handle 10 may be attached to the other leg strap 102 of the safety harness 100 (shown for example in FIG. 10). In accordance with an example embodiment, the body of the handle 10 may include a handle portion 20, a first leg portion 22, and a second leg portion 24. In some example embodiments, the handle portion 20, the first leg portion 22, and the second leg portion 24 may be flat elongated members. The first leg portion 22 and the second leg portion 24 extend from a first end of the handle portion 20. In some example embodiments, the body of the handle 10 may be formed as a double layer of webbing. In such example embodiments, the handle portion 20, the first leg portion 22, and the second leg portion 24 are each formed of two layers of webbing. The two layers of the first leg portion 22 may be stitched together proximate where the first leg portion 22 join the first end of the handle portion 20 and the two layers of the second leg portion 24 may be stitched together where they join the first end of the handle portion 20. The first leg portion 22 and the second leg portion 24 may extend in opposite directions from the first end of the handle portion 20, as shown for example in FIG. 5. In some example embodiments, the handle portion 20, the first leg portion 22, and the second leg portion 24 may be formed from a single length of webbing. For example, the length of webbing may begin at the first leg portion 22 proximate the first end of the handle portion 20. The length of webbing may extend to a distal end of the first leg portion 22 and then double back to the first end of the handle portion 20, thus making the first leg portion 22 a double layer of webbing. The length of webbing may continue to a distal end of the handle portion 20 and double back to the first end of the handle portion 20, thus making the handle portion 20 a double layer of webbing. The length of webbing may then continue to a distal end of the second leg portion 24 and double back to the first end of the handle portion 20, thus making the second leg portion 24 a double layer of webbing. Stitching or other suitable methods of attachment may be employed to secure the double layers of webbing in each of the handle portion 20, the first leg portion 22, and the second leg portion 24 to each other. In some example embodiments, the handle portion 20, the first leg portion 22, and the second leg portion 24 may be formed from a single length of webbing with only the handle portion 20 being formed as a double layer of webbing. For example, the length of webbing may begin at a distal end of the first leg portion 22, extend to a distal end of the handle portion 20 and double back to the first end of the handle portion 20, thus making the handle portion 20 a double layer of webbing, but the first leg portion 22 a single layer of webbing. The length of webbing may then extend to a distal end of the second leg portion 24, making the second leg portion a single layer of webbing. The double layers of webbing of the handle portion 20 may then be attached to each other. It will be appreciated that in some example embodiments, the handle portion 20 and just one of the first or second leg portions 22,24 may be formed as a double layer of webbing. In some example embodiments, the handle portion 20, the first leg portion 22, and the second leg portion 24 may be formed from multiple pieces of webbing attached together.

The first leg portion 22 and the second leg portion 24 are structured to be placed flush against one of the leg straps 102 of the safety harness 100 and attached to the leg strap 100 of the safety harness 100, as shown for example in FIG. 9. In an example embodiment of the disclosed concept, the first leg portion 22 and second leg portion 24 are attached to the leg strap 102 of the safety harness 100 by being stitched to the leg strap 102 of the safety harness 100. However, it will be appreciated that other methods of attaching the first leg portion 22 and the second leg portion 24 to the leg strap 102 may be employed without departing from the scope of the disclosed concept. For example and without limitation, clamping, riveting, bonding, or other types of attachment may be employed without departing from the scope of the disclosed concept. When the first leg portion 22 and the second leg portion 24 are attached to the leg strap 102, they are substantially flush with the leg strap 102 and the handle portion 20 is capable of extending away from the first leg portion 22 and the second leg portion 24, as shown for example in FIG. 9. A user is able to pull on the handle portion 20, as shown for example in FIG. 8, to pull the leg straps 102 downward and relieve the pressure of the leg straps 102 and allow the user to adjust the position of the leg straps 102. In this manner, the user may slide the leg strap 102 down the user's leg and adjust from a vertical position to a sitting position.

The handles 10 in accordance with an example embodiment further include a first attachment element 14 and a corresponding second attachment element 16 (as shown for example in FIG. 5). The first attachment element 14 is structured to selectively attach to the second attachment element 16. The first attachment element 14 is attached to the handle portion 20 at an area of the handle portion 20 distal to the first and second leg portions 22,24. The second attachment element 16 is attached to one of the first and second leg portions 22,24 at an area of the first or second leg portions 22,24 distal to the handle portion 20. Attaching the first attachment element 14 to the second attachment element 16 causes the distal end of the handle portion 20 to be attached to the distal end of the one of the first and second leg portions 22,24. When the first attachment element 14 is attached to the second attachment element 16, the handle portion 20 is retained in a position substantially flush with the first or second leg portion 22,24 and the leg strap 102, as shown for example in FIG. 11. When a user does not need to use the handle portion 20 to adjust the leg strap 102, the user may attach the first and second attachment mechanisms 14,16 to retain the handle portion 20 flush with the first or second leg portion 22,24 and the leg strap 102. In this manner, the handle portion 20 is kept out of the way and avoids them becoming inadvertently snagged. In the case of a fall, where a user needs to use the handle portion 20 to adjust the leg strap 102, the user may detach the first and second attachment mechanisms 14,16. Once the first and second attachment mechanisms 14,16 are detached, the handle portion 20 may extend away from the first and second leg portions 22,24, as shown for example in FIGS. 8 and 9, and the user may grasp the handle portion 20 and use the handle 10 to assist with pulling the leg strap 102 and adjusting to a seated position.

In an example embodiment, the first and second attachment elements 14,16 may be corresponding snap elements (e.g., without limitation, corresponding male and female snap elements). However, it will be appreciated that other mechanisms for selective attachment may be employed without departing from the scope of the disclosed concept. For example and without limitation, corresponding hook and loop elements may be employed as the first and second attachment elements 14,16. As another example, adhesives may be employed as the first and second attachment elements 14,16. While some examples are provided, it will be appreciated that any suitable mechanisms for selective attachment may be employed.

In some example embodiments of the disclosed concept, the first and second attachment mechanisms 14, 16 are structured to be attached by applying a force to press the first and second attachment mechanisms 14,16 together. Similarly, in some example embodiments, the first and second attachment mechanisms 14,16 are structured to be released by applying a force to pull the first and second attachment mechanisms 14,16 apart. It will be appreciated that the forces to press together or pull apart the first and second attachment mechanisms 14,16 in some example embodiments may be applied directly or indirectly to the first and second attachment mechanisms 14,16. For example and without limitation, pulling on the handle portion 20 or a knob element 12 attached to an end of the handle portion 20 may apply an indirect force to pull apart and release the first and second attachment mechanisms 14,16. In the case of a fall, it may be difficult for a user to interact with the first and second attachment mechanisms 14,16 directly, so it can be beneficial to be able to release the first and second attachment mechanisms 14,16 by pulling on the handle portion 20 or a knob element 12 attached to the handle portion 20.

In some example embodiments, the handle 10 may include a gripping element suitable to assist a user with gripping the handle 10. In some example embodiments, the gripping element is a knob element 12 attached to an end of the handle portion 20 distal to the first and second leg portions 22,24. However, it will be appreciated that other types of gripping elements to assist a user with gripping the handle 10 may be employed without departing from the scope of the disclosed concept. A knob element 12 in accordance with an example embodiment is shown in FIG. 7, and non-limiting examples of the knob element 12 attached to the handle portion 20 are shown in FIGS. 3-6. The knob element 12 may have a greater thickness than the handle portion 20, as shown for example in FIG. 5. In some example embodiments, the knob element 12 includes a hollow partially spherical shape portion 30 and a collar 32. The collar 32 may have a shape corresponding to the shape of the handle portion 20 (e.g., without limitation rectangular). In some example embodiments, the collar 32 may form an aperture structured to receive an end of the handle portion 20. The handle portion 20 may be attached to the knob element 12 in any suitable manner. In some example embodiments, the handle portion 20 is attached to the knob element 12 by stitching the handle portion 20 to the collar 32 of the knob element 12. However, it will be appreciated that other suitable methods of attachment may be employed. For example and without limitation, the handle portion 20 may be clamped or bonded to the knob element 12.

In some example embodiment, the knob element 12 may be thicker and/or wider than handle portion 20. Increased thickness or width allows a user to more easily locate the knob element 12. As the knob element 12 is attached to the handle portion 20, pulling the knob element 12 will also pull the handle portion 20 and will cause the first and second attachment elements 14,16 to release. In some example embodiments, the knob elements 12 includes the hollow partially spherical shape portion 30. The hollow partially spherical shape portion 30 allows the user to have an enhanced grip on the knob element 12. For example, the user may insert their thumb into the hollow portion of the hollow partially spherical shape portion 30 which can assist the user with retaining a grip on the handle 10 while the user pulls on the handle 10 and repositions the leg strap 102. It will be appreciated that the knob element 12 may have different shapes without departing from the scope of the disclosed concept. For example and without limitation, the hollow partially spherical shape portion may be replaced with a spherically shaped portion. Other shapes such as rectangular, oblong, or other suitable shapes may be employed in the knob element 12 without departing from the scope of the disclosed concept.

In some example embodiments, the knob element 12 may be composed of a resilient fabric material. The material may be resilient such that the knob element 12 will retain its shape, but experience some deformation under pressure. In some example embodiments, the knob element 12 may be composed of a more rigid material such as, for example and without limitation, a plastic or metallic material. It will be appreciated that the knob element 12 may be composed of any suitable material without departing from the scope of the disclosed concept.

A size of the handle 10 may be suitable such that the first and second leg portions 22,24 can be attached to the leg strap 102 without extending outside the bounds of the leg strap 102. The handle portion 20 may be sized so as to provide the user with a sufficient are to grip and pull the handle portion 20 while not providing excessive length that could allow the handle portion 20 to inadvertently become snagged. In some example embodiments, the first and second leg portions 22,24 and the handle portion 20 each have a length within a range of about 2-5 inches and a width within a range of about 0.5-2 inches. It will be appreciated that these dimensions are provided as an example and the dimensions may vary without departing from the scope of the disclosed concept.

In accordance with example embodiments of the disclosed concept, the handles 10 are compact and able to be stored securely while not in use. The handles 10 are easy to locate when a user is under duress, such as after a fall, and are easy for the user to deploy. The handles 10 are easy to use and provide the user with a better grip and mechanical advantage to pull the handles 10 and leg straps 102 to adjust the position of the user. Further, in some instances, the user may be wearing gloves. The handles 10 are also easy to deploy and use by a user that is wearing gloves.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A handle for a safety harness comprising:
a handle portion;
a first leg portion extending from a first end of the handle portion;
a second leg portion extending from the first end of the handle portion;
a first attachment element attached to a portion of the handle portion distal from the first end of the handle portion; and
a second attachment element attached to a portion of the first leg portion or the second leg portion distal from the first end of the handle portion, wherein the first attachment element is structured to selectively attach to the second attachment element.

2. The handle of claim 1, wherein the first leg portion and the second leg portion are flat elongated members.

3. The handle of claim 1, wherein the handle portion, the first leg portion, and the second leg portion are composed of webbing.

4. The handle of claim 3, wherein at least one of the handle portion, the first leg portions, and the second leg portion are formed as a double layer of webbing.

5. The handle of claim 3, wherein the handle portion, the first leg portion, and the second leg portion are formed from a single length of webbing.

6. The handle of claim 1, wherein the first attachment element and the second attachment element are corresponding snap elements.

7. The handle of claim 1, wherein the first attachment element and the second attachment element are structured to attach to each other in response to a force pressing the first attachment element and the second attachment element together.

8. The handle of claim 1, wherein the first attachment element and the second attachment element are structured to release from each other in response to a force pulling the first attachment element and the second attachment element away from each other.

9. The handle of claim 1, wherein the handle portion is structured to lay flush against the first leg portion or the second leg portion when the first attachment element is attached to the second attachment element.

10. The handle of claim 9, wherein the handle portion is structured to extend away from the first leg portion and the second leg portion when the first attachment element and second attachment element are detached from each other.

11. The handle of claim 1, further comprising:
a gripping element attached to a second end of the handle portion distal from the first end.

12. The handle of claim 11, wherein the gripping element is a knob element including a collar attached to the second end of the handle portion and a hollow partially spherical shape portion.

13. The handle of claim 11, wherein the gripping element has a width or thickness greater than a width or thickness of the handle portion.

14. A handle for a safety harness comprising:
a handle portion;
a first leg portion extending from a first end of the handle portion;
a second leg portion extending from the first end of the handle portion; and
a gripping element attached to a second end of the handle portion distal from the first end,
wherein the handle portion is structured to selectively attach to and lay flush against the first leg portion or second leg portion, and wherein the handle portion is structured to selectively detach from and extend away from the first leg portion or the second leg portion.

15. The handle of claim 14, wherein the handle portion, the first leg portion, and the second leg portion are composed of webbing.

16. The handle of claim 14, wherein the gripping element is a knob element including a collar attached to the second end of the handle portion and a hollow partially spherical shape portion.

17. A safety harness comprising:
a first leg strap structured to loop around a first leg of a user; and
a first handle attached to the first leg strap, the first handle comprising:
a handle portion;
a first leg portion extending from a first end of the handle portion;
a second leg portion extending from the first end of the handle portion;
a first attachment element attached to a portion of the handle portion distal from the first end of the handle portion; and
a second attachment element attached to a portion of the first leg portion or the second leg portion distal from the first end of the handle portion, wherein the first attachment element is structured to selectively attach to the second attachment element.

18. The safety harness of claim 17, wherein the first leg portion and the second leg portion are attached to the first leg strap, and wherein the first leg portion and the second leg portion lay flush against the first leg strap.

19. The safety harness of claim 17, wherein the first handle includes a gripping element attached to a second end of the handle portion distal from the first end.

20. The safety harness of claim 17, further comprising:
a second leg strap structured to loop around a second leg of the user; and
a second handle attached to the second leg strap, the second handle comprising:
a handle portion;
a first leg portion extending from a first end of the handle portion;
a second leg portion extending from the first end of the handle portion;
a first attachment element attached to a portion of the handle portion distal from the first end of the handle portion; and
a second attachment element attached to a portion of the first leg portion or the second leg portion distal from the first end of the handle portion, wherein the first attachment element is structured to selectively attach to the second attachment element.
